(19) United States
(12) Patent Application Publication
(10) Pub. No.: US 2025/0223866 A1
(43) Pub. Date: Jul. 10, 2025

(54) FILM PRODUCT FOR APPLICATION TO A BUILDING ENVELOPE FOR PROTECTION AGAINST BIRD IMPACT

(71) Applicant: BIRDSHADES INNOVATIONS GMBH, Leoben (AT)

(72) Inventors: Christoph CERNY, Graz (AT); Dominique WADDOUP, Graz (AT)

(21) Appl. No.: 18/852,897

(22) PCT Filed: Mar. 30, 2023
(86) PCT No.: PCT/AT2023/060105

§ 371 Date: Sep. 30, 2024

(30) Foreign Application Priority Data
Mar. 31, 2022 (AT) A 89-2022

(51) Int. Cl. E06B 9/24; A01M 29/08; G02B 5/08

(52) U.S. Cl. CPC E06B 9/24; A01M 29/08; G02B 5/0891; E06B 2009/2405

(57) ABSTRACT

The present disclosure relates to a film product for application to a building envelope, in particular a transparent section of the building envelope, for protection against bird strikes. The film product has a film body with a planar extension. The film body has at least one UV bird protection section with an optical effect in the UV range as a UV bird protection function. The at least one UV bird protection section has a bird protection position with respect to the film body. The film product also has at least one installation marking with an optical effect in the VIS range visible to humans. The installation marking has at least one orientation section, which indicates the bird protection position of at least one UV bird protection section in the VIS range.

### CROSS-REFERENCE TO RELATED APPLICATIONS

This application is a U.S. National Stage of International Application No. PCT/AT2023/060105, filed Mar. 30, 2023, which claims the benefit of and priority to Austrian Patent Application No. A 89-2022, filed Mar. 31, 2022, each of which is hereby incorporated by reference herein in its entirety.

### TECHNICAL FIELD

The present invention relates to a film product for application to a building envelope for protection against bird strikes, a method for applying such a film product, and a façade element having such a film product.

### BACKGROUND

It is known that there is a risk of a so-called bird strike in the case of transparent sections of building envelopes. This means that birds in flight do not perceive this transparent section of the building envelope as an obstacle, or do so too late, and accordingly fly into this transparent section. This often leads to injuries or even to the death of the bird.

It is also known for film products to be used on the building envelope which help the birds to perceive these transparent sections as an obstacle. In addition to known solutions with bird protection functions which function in the VIS range (visible) which is visible to humans, so-called UV bird protection sections are also in use which achieve their effect in the UV range. This should be understood to mean that UV bird protection sections have a different optical effect in the UV range compared to other sections of a film product, for example with increased or reduced absorption or different reflective behaviour. Since a large number of bird species are able to perceive such differences in the UV range, a protective effect against bird strikes can be guaranteed by the geometric design of the UV bird protection sections.

A disadvantage of the known solutions is that the UV bird protection function cannot be perceived by humans due to its effect in the UV range. While this lack of perceptibility in the VIS range is advantageous for humans when the film product has been applied, this leads to a more difficult installation situation. For example, due to the invisibility of the UV bird protection section, it is not apparent to the installer in which position and/or in which orientation the UV bird protection section is arranged on the film body. However, since the UV bird protection function provides its effect through the geometric correlation to the building envelope and/or through the geometric correlation to other UV bird protection sections of the same and/or a different film body, the orientation of the film product and the associated orientation of the UV bird protection section is of essential importance for its functional reliability in terms of protection against bird strikes.

### SUMMARY

It is the object of the present invention to remedy, at least in part, the disadvantages described above. In particular, the object of the present invention is to achieve a better effect by means of UV bird protection sections, in a cost-effective and simple way, and at the same time to facilitate installation.

The above object is achieved by a film product with the features of claim 1, a method with the features of claim 15 and a facade element with the features of claim 17. Further features and details of the invention are disclosed in the dependent claims, the description and the drawings. Naturally, features and details described in connection with the film product according to the invention also apply in connection with the method according to the invention and the facade element according to the invention and vice versa, so that, with regard to disclosure, mutual reference is or can always be made to the individual aspects of the invention.

The core idea according to the invention is that a film product for application to a building envelope, in particular a transparent section of the building envelope, can be used to provide protection against bird strikes. This film product has a film body with a planar extension. The film body is provided with at least one UV bird protection section with an optical effect in the UV range as a UV bird protection function. The UV bird protection section has a bird protection position in relation to the film body. Furthermore, at least one installation marking with an optical effect in the VIS range visible to humans is provided. This installation marking is provided with at least one orientation section which indicates the bird protection position of at least one UV bird protection section in the VIS range.

A building envelope can be understood as any type of material, in particular those that are reflective and/or transparent. These can for example be glass surfaces, plastic surfaces and/or metal surfaces.

The film product can be applied to the surface of the building envelope and/or embedded in the material of the building envelope. For example, a multi-layered material is conceivable in which the film product, in particular a film body of the film product, forms one or more of the layers. Formation together with the material of the building envelope, for example by co-extrusion, is also conceivable here.

A film product in the sense of the present application may take different forms. For example, a multi-layered design for the film body is conceivable. However, simpler, in particular single-layer film bodies are also possible. Of course, a more complex design with different partial sections which adjoin each other is also to be understood as a film product in the sense of the present invention.

The core idea of the invention is based on applying a bird protection function invisible to humans to a transparent section of a building envelope with the aid of a film product. It is irrelevant whether the film product is applied to the building envelope subsequently or is already introduced during the pre-installation process or even during the production process of the section, in particular the façade element which will be explained later.

In order to provide the bird protection function, the film product according to the invention includes at least one UV bird protection section. The UV bird protection section has an optical effect in the UV range and thus in the range that is not visible to humans. The protective effect can for example be achieved by geometric shapes. For example, stripe patterns, grid patterns, raster patterns, dot patterns, but also other, more complex geometric shapes can provide the one or more UV bird protection sections. In the context of this disclosure, a particularly simple example is chosen to describe the functionality in more detail. This is a strip-formed pattern with UV bird protection sections which alternate either with free areas or with other UV bird protection sections with a different optical effect in the UV range. However, the present invention is by no means limited to this simple embodiment, but is independent of the actual positioning, shaping and/or orientation of the individual UV bird protection sections.

In the example mentioned, several strip-formed UV bird protection sections can be formed parallel to each other, directly next to each other or spaced apart in a raster in the film body. For the bird, with a perceptive capacity in the UV range, a strip-formed barrier is thus formed which it perceives as an arrangement of grid bars. Depending on the size of the bird, this means that, while it can perceive the clear strips between the UV bird protection sections as free space, this is preferably so narrow that the bird does not choose it as a flight path. In other words, in this embodiment of the UV bird protection section, a bird protection grid is formed which the bird perceiving within the UV range can see, and at the same time this grid is invisible for humans.

It is also clear to see here that this depends on the orientation and positioning in which the film product and thus the at least one UV bird protection section is actually applied to the building envelope. If, for example, the building envelope is a glazed façade, several film products must be applied next to each other. In this case in particular, it is necessary that for example film products directly adjacent to each other continue the explained striped pattern in such a way that the geometric effect is retained in the correlation of the strip-formed UV bird protection sections to each other, even when several film products are adjacent to each other. This is only the case if the orientation of the film products relative to each other corresponds to a specified and desired shape. However, when applying the film product, the installer cannot see in which positioning and/or orientation the UV bird protection sections are arranged, since precisely due to their functionality they are not recognisable by humans.

The advantages according to the invention are manifest in the installation situation as explained here. For example, while the installer will not be able to recognise the at least one UV bird protection section, they can see the installation marking visible in the VIS range. The installation marking has at least one orientation section which contains an indicator for the bird protection position. The orientation of the bird protection position can be indicated in a variety of ways. In addition to an indirect, for example informative display, such as a label, an arrow representation or the like, it is also possible that the very positioning of the orientation section already provides the indication of the correct alignment of the film product for a correct and accurate alignment of the UV bird protection sections. A direct indication, for example by overlapping or partially overlapping the installation marking with the at least one UV bird protection section, is also conceivable within the framework of the present invention. An orientation section can therefore provide an implicit or an explicit indication possibility for the bird protection position.

It should also be pointed out that a bird protection position within the meaning of the present invention goes hand in hand with the desired protective function and the associated geometric design of the at least one UV bird protection section. For example, the bird protection position can include the actual relative positioning of a UV bird protection section in relation to the edge of the film body. The bird protection position can also indicate a relative position between two UV bird protection sections. Of course, more complex relationships with regard to positioning and alignment are also to be understood as bird protection positions within the framework of the present invention.

A film product according to the invention now makes it possible that, when installing the film product on the building envelope, installation markings which are visible in the visual range are recognisable by the installer which allow the film product to be applied with a high degree of certainty in such a way and above all in such an orientation that the UV bird protection sections, which are not visible to the installer, are positioned on the building envelope with the desired orientation. In this way, incorrect installation, in particular of several film products next to each other, can be ruled out with a high degree of certainty.

Another installation situation in which alignment is facilitated by the design according to the invention is a double-sided application to a transparent section of a building envelope. This can, for example, be a glass partition wall at a bus stop which can be flown towards by birds from both sides. The double-sided application creates the desired protective effect on both sides in an identical way. However, care must be taken to ensure that the UV bird protection sections are aligned congruently. In other words, for example, the strip-formed UV bird protection sections must be located in identical and thus congruent positions on both sides of the glass partition wall. Otherwise, there would be a risk that the UV bird protection sections on both sides would complement each other and thus impair or even negate the protective function.

It can bring advantages if, in a film product according to the invention, the orientation section has an orientation and/or a position that correlates with the orientation of the at least one UV bird protection section, is in particular aligned along the orientation of the at least one UV bird protection section and/or at least partially corresponds to the bird protection position. Different embodiments of the orientation section are explained here. In particular, this involves a direct indication of the protection function, whereby, in the simplest way, one or more section(s) of the UV bird protection section are simply covered by the orientation section and thus reproduced directly. However, in order to reduce or even minimise the visibility of the UV bird protection sections as far as possible, the orientation section will preferably be designed significantly smaller than the at least one bird protection section. Different types of orientation sections can also be combined with each other within the framework of the present invention. The positioning and/or the orientation can in particular also have an informative character, which will be explained later, in order to display this orientation information.

A further advantage can be achieved if, in a film product according to the invention, the at least one orientation section of a film product according to the invention has an information section that contains visual information about the bird protection position. While the orientation section can already create an indicative function through its very positioning and alignment, the information section can also provide information content either in the form of text, an angle representation and/or an arrow representation, and in this way specify an orientation and/or relative positioning for the installation. A combination of a directly acting orientation section and an indirectly acting information section is of course also conceivable within the framework of the present invention.

It is also advantageous if, in a film product according to the invention, the bird protection position of the at least one UV bird protection section has at least one of the following forms:
extension of the at least one UV bird protection section
location of the at least one UV bird protection section relative to the edges of the film body
location of at least two UV bird protection sections relative to each other

The above list is non-exhaustive. For example, the extension of at least one bird protection section can be an elongated extension of a strip-formed UV bird protection section. The location of such a UV bird protection section relative to the edges can also be indicated as a relative position, for example to which of the two edges the respective UV bird protection section is located more closely adjacent. If UV bird protection sections are arranged in several ways, for example in the strip-formed design already explained, the orientation of these strips and/or the distance between these strips can also be part of the bird protection position in the manner indicated.

It also brings advantages if, in a film product according to the invention, a surface side of the film body is provided with a cover film, in particular to cover an adhesive surface of this surface side, whereby the installation marking is at least partially arranged in and/or on this cover film. This embodiment is preferred if the film body is free of an installation marking. In other words, the installation marking is arranged on a cover film separate from the film body, and in this way it is possible to remove the installation marking after installation is completed or even during installation. This cover film can also be referred to as a release liner if it covers the adhesive surface in such a way. Once the cover film has been removed and the film product has been aligned in the desired way during installation, removing the cover film means that the installation marking also disappears. In the arranged position on the building envelope, the installation marking is thus no longer visible and consequently nor does it interfere with the view through the transparent section. Of course, this arrangement of the installation marking on a cover film can also be freely combined with other arrangements of an installation marking within the framework of the present invention.

Another advantage is if, in a film product according to the invention, the installation marking is part of the film body. This may therefore represent an alternative or additional embodiment in accordance with the preceding paragraph. In this embodiment, the installation marking is thus integrated into the material of the film body and/or printed on the film body. The application of the installation marking can already be part of a production process of the film body, so that the installation marking is also applied in place at the same time, or at least in the same manufacturing process, during the production of the UV bird protection sections. In this way, an incorrect placement of the installation marking, which would accordingly lead to a faulty installation, is prevented with a high degree of certainty. In other words, the probability of incorrect printing of the installation marking is reduced to a minimum. The installation marking can for example be part of the adhesive between individual film layers. However, it is also possible to integrate the installation marking into one or more UV bird protection section(s) through corresponding selection of pigments or dyes. Fluorescent installation markings are also conceivable in principle here, the basic visibility of which under the influence of daylight can be improved for the installer during installation by making appropriate use of a lighting device, for example a UV lamp.

A further advantage is if, in a film product according to the invention according to the preceding paragraph, the installation marking, in particular the at least one orientation section, has a temporary effect in the VIS range. This should be understood to mean that the installation marking loses its effect in the VIS range, at least partially, after a certain retention time. For example, this can be achieved in that the installation marking fades under exposure to UV light. In the rolled-up state of the film product, the installation marking is essentially protected by the film product itself against the effect of sunlight, and thus against the effect of UV rays. During application, the film product is unrolled from the roll and the installation marking becomes visible as it is unrolled. Once the installation has been completed, the installation marking on the transparent section of the building envelope is now exposed to the elements and also, in particular, to the effect of sunlight. If a dye is selected for the installation marking which fades due to UV radiation, the installation marking can reduce its temporary effect in the VIS range by slowly fading. In other words, the installation marking is provided for installation and fades over a defined marking time as the temporary effect wears off. Integration into the film thus brings increased visibility and nonetheless prevents an undesirable impairment of the appearance of the film product after arrangement on the building envelope and after fading is complete.

It also brings advantages if, in a film product according to the invention, the installation marking is continuous and/or repetitive. As has already been explained, film products can in particular be arranged on rolls. This means that the desired length of the film product can be cut off depending on the desired length and depending on the different size of the section of the building envelope. The fact that, in this embodiment, not only an installation marking but a continuous or repetitive marking is provided means that the advantage of marking the installation direction and indicating the bird protection position can be achieved for all different installation situations.

It can also be an advantage if, in a film product according to the invention, the at least one orientation section has a visibility at the edge of the spectrum visible to humans, towards the UV range, in particular in the range between 5 and 20 nanometres distance from the UV range. In other words, the orientation section is in this case only just visible to humans, since it lies very close to the UV range. Due to the fact that the UV range can be defined differently depending on the literature, the orientation section is for example located in the range between 405 and 425 nanometres. As a result, the orientation section is basically visible to humans in the VIS range, but only to a small extent. In other words, the orientation section recedes into the background when the building envelope is viewed normally, but is still sufficiently visible to the installer to enable aligned and correct installation.

Further advantages can be achieved if, in a film product according to the invention, the installation marking has an origin section indicating the origin of the film product which is in particular at least partly formed by the orientation section. Preferably, the origin section is completely formed by the orientation section and can, for example, include a logo or the like. This orientation is always visible, so that in addition to ensuring correct and proper installation, the origin section also provides an indication of quality and function. This not only ensures the correct application of the film product during installation, it also provides an indication of correct application and the associated functionality in terms of protection against bird strikes following installation.

It can bring further advantages if, in a film product according to the invention, the installation marking, in particular the at least one orientation section, is only visible from one side of the film body. Polarisation filters and/or textured paints can for example be used here to achieve only one-sided visibility of the installation marking. In particular, this is a visibility from the side of the film body which is visible to the installer during installation. This can for example be a cover film on the inner side, whereby the installation marking is visible to the installer through the transparent film product.

It is also advantageous if, in a film product according to the invention, the bird protection position of the at least one bird protection section includes a trimming allowance which is trimmed off during installation on the building envelope. As already explained in the introduction, a direct abutment and thus an adjacent installation of film products may be necessary in the case of wide building envelopes. In order to enable a gap-free application of two film products butt-joined next to each other, an overlap is usually provided. Since, as also already explained, the geometric correlation accounts for part of the protective effect of the UV bird protection sections, the trimming allowance allows this to be taken into account in the arrangement of the UV bird protection sections in the film body. In other words, it is taken into account that when the film body is applied in a butt join, part of the film body is trimmed off again, so that in the final position, i.e. after the trimming allowance has been trimmed off, the desired relative positioning of the UV bird protection section is again ensured. This trimming allowance can for example be designed for a vertical cut in the range between 1 and 3 centimetres, spaced apart from the respective edge of the film body.

In a film product according to the preceding paragraph, it is advantageous if the installation marking, in particular as part of the at least one orientation section, indicates the trimming allowance in a qualitative and/or quantitative manner. This should be understood to mean that not only can the presence of the trimming allowance be indicated in a qualitative manner, its distance from the respective edge can also be indicated, for example in centimetres. The degree of any necessary overlap is visually specified, making installation even easier. In other words, the installation marking can represent not only the desired orientation relative to another film product, but also the quantitative orientation of an overlap during the installation process.

It can also be advantageous if, in a film product in accordance with the two preceding paragraphs, such an installation marking is arranged, at least partly, in particular completely or substantially completely, in the trimming allowance. This means that after the trimming allowance has been trimmed off, the installation marking is also trimmed off and thus removed. As already explained, it is advantageous to have as little influence as possible on the transparency of the section of the building envelope in the VIS range. If the installation marking is trimmed off together with the trimming allowance, it can no longer affect the transparency of the section after installation has been completed.

The subject matter of the present invention also includes a method for applying a film product according to the present invention to a building envelope, comprising the following steps:
determining the bird protection position of the at least one UV bird protection section using the at least one orientation section,
arranging the film product on the building envelope on the basis of the specific bird protection position,
fixing the film product in the arranged position.

Thus, a method according to the invention has the same advantages as have been explained in detail with reference to a film product according to the invention. The individual steps of the method can be carried out simultaneously, in the order described, but also in a different order. The decisive point here is in particular that, alternatively or in combination, an alignment and a relative positioning in relation to the adjacent film which has already been applied are also possible.

It can be advantageous if, in a method according to the invention, the film product is applied directly adjacent to a film product already applied to the building envelope, in particular comprising the following steps:
arranging the film product with an overlap over the already applied film product,
trimming off the overlap.

This refers to a butt-joined adjacent application, so that the overlap is in particular part of a trimming allowance, as has already been explained. This means that, either before or after trimming off the overlap in the arranged position, the film product is now adhesively bonded in place in a butt join. An advantage is achieved here, since a gap-free application of film products in a butt join in accordance with the invention can be guaranteed with a high degree of certainty in the correct relative orientation of the film products with respect to each other.

A further subject matter of the present invention is a façade element for a section of a building envelope, in particular in the form of a window and/or a glass element, comprising a main façade body having a film product according to the invention. The installation marking is part of the film body of the film product. Alternatively or additionally, it is also possible to design the installation marking as part of the façade element and thus separately from the film body. The façade element can contain information about the orientation and in particular the bird protection position of the UV bird protection sections in the film body, so that when introducing a façade element, for example a pane of glass, this orientation can be taken into account in the same way as explained above with regard to the application of the film product to the section of the building envelope. The film product can for example be applied to the façade element on the ground in front of a building, as a preparatory step, and the finished pre-assembled façade element can then be attached to the facade of the building envelope. Alternatively or additionally, however, the film body can also be introduced during the production of the façade element, for example between several panes of glass. Thus, such a façade element also brings with it the same advantages as have been explained in detail with reference to a film product according to the invention.

### BRIEF DESCRIPTION OF THE DRAWINGS

Further advantages, features and details of the invention are explained in the following description, in which exemplary embodiments of the invention are described in detail with reference to the drawings. The features mentioned in the claims and in the description may in each case be essential to the invention individually or in any combination. In each case schematically:

FIG. 1 shows an embodiment of a film product according to the invention in the UV range,

FIG. 2 shows the embodiment of FIG. 1 in the VIS range,

FIG. 3 shows a further embodiment of a film product in the VIS range,

FIG. 4 shows a further embodiment of a film product in the VIS range,

FIG. 5 shows another embodiment of a film product in the VIS range,

FIG. 6 shows a further embodiment of a film product in the VIS range,

FIG. 7 shows a relative positioning of two film products in the VIS range,

FIG. 8 shows the embodiment of FIG. 7 in the UV range,

FIG. 9 shows a misalignment of FIG. 7 in the VIS range,

FIG. 10 shows the misalignment of FIG. 9 in the UV range,

FIG. 11 shows a representation of a trimming allowance,

FIG. 12 shows a design of a building envelope with several façade elements.

### DETAILED DESCRIPTION

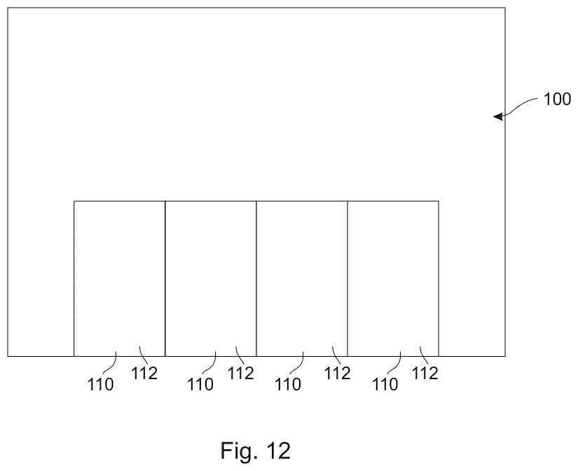

According to the invention, the object is to provide a building envelope 100, as shown in FIG. 12, with a bird protection effect. Here, the building envelope 100 shown in FIG. 12 has a partially-glazed façade with four façade elements 110 which have either already been provided with a film product 10 according to the invention during the production of the main façade body 112 or are subsequently provided with a film product 10 according to the present invention by affixing this to the individual façade elements 110 as transparent sections.

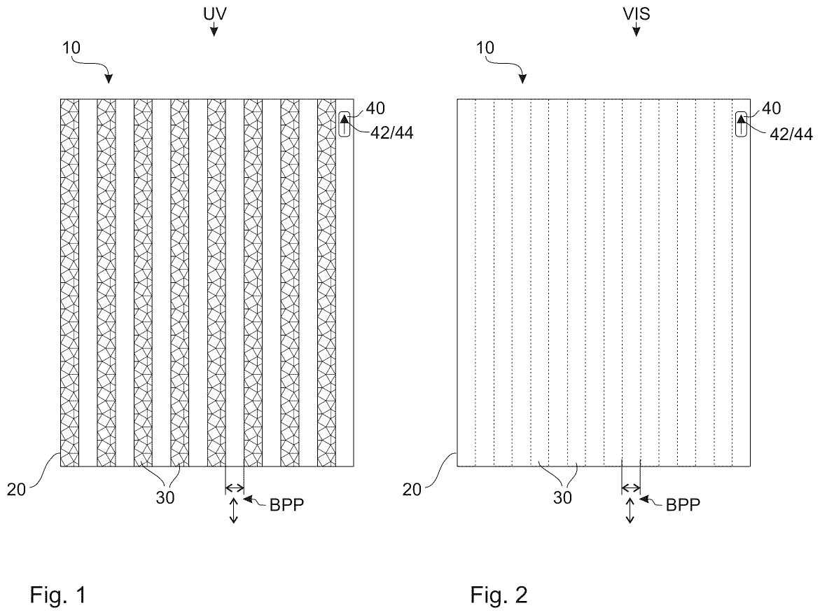

FIG. 1 shows a particularly simple possibility of a bird protection function, which does not however limit the invention. To illustrate the function, FIG. 1 shows the UV range UV, i.e. the perception as experienced by a bird. Here, several strip-formed UV bird protection sections 30 are integrated into a film body 20 which provides the film product 10. The bird protection effect is formed by a bird protection position BPP of the individual protection sections 30, so that here the bird protection position BPP forms the direction of extension, represented by the vertical double arrow, and the gap width between adjacent UV bird protection sections 30, represented here by the horizontal double arrow. An installation marking 40 is shown in the upper right corner of the film product 10. This contains an orientation section 42, which in this case represents an arrow-shaped information section 44. It is thus shown that the arrow pointing upwards shows in which direction the bird protection position BPP contains the individual UV bird protection sections 30 in an aligned manner. This provides an information display, which also represents information for the installer in the VIS range, as shown in FIG. 2. As FIG. 2 shows, the individual UV bird protection sections 30 are not recognisable in the VIS range. Simply for the sake of clarity, they are shown here schematically with dashed lines, whereas for the installer the film body 20 appears as a uniform and undivided surface. In the VIS range, they can only recognise the installation marking 40, so that they now know in which orientation the UV bird protection sections 30 lie in front of him, although they cannot see them.

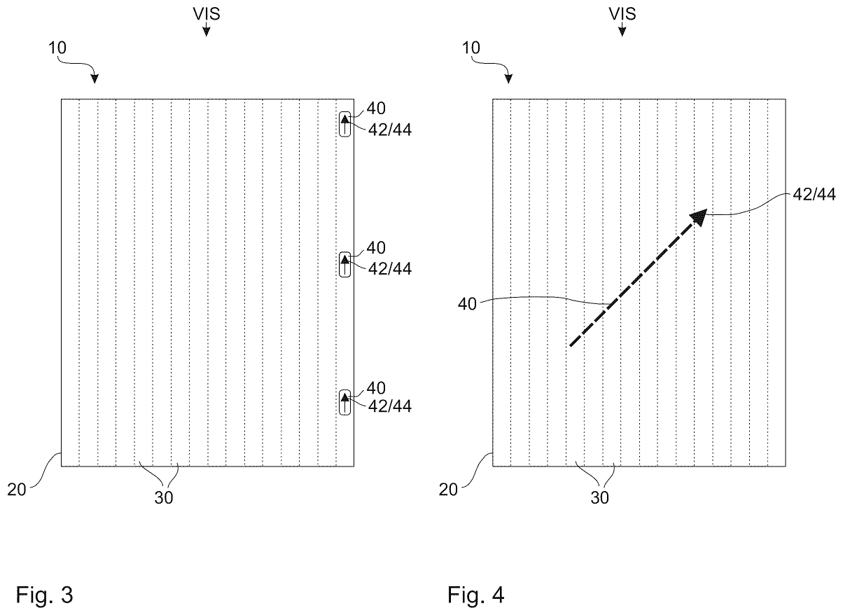

FIG. 3 shows a further development of such a film product 10. Since film products 10 of this type are often transported and made available for installation rolled up on rolls, a repetitive application of an identically repeating installation marking 40 takes place here. These are all designed with an arrow-shaped information section as orientation section 42, as explained with reference to FIGS. 1 and 2.

FIG. 4 shows another variant which represents the installation marking 40 substantially across the film body 20 in the form of a watermark. The orientation section 42 is here again provided as an arrow with an information section 44 which points to the top right and thus again clearly correlates the desired installation position with the bird protection position BPP. Such a watermark is in particular designed in such a way that the effect in the VIS range is designed for a temporary fading period, so that, for example by using UV unstable dyes in the installation marking, this fades over time through exposure to sunlight after being applied to a building envelope 100 and thus loses visibility over time.

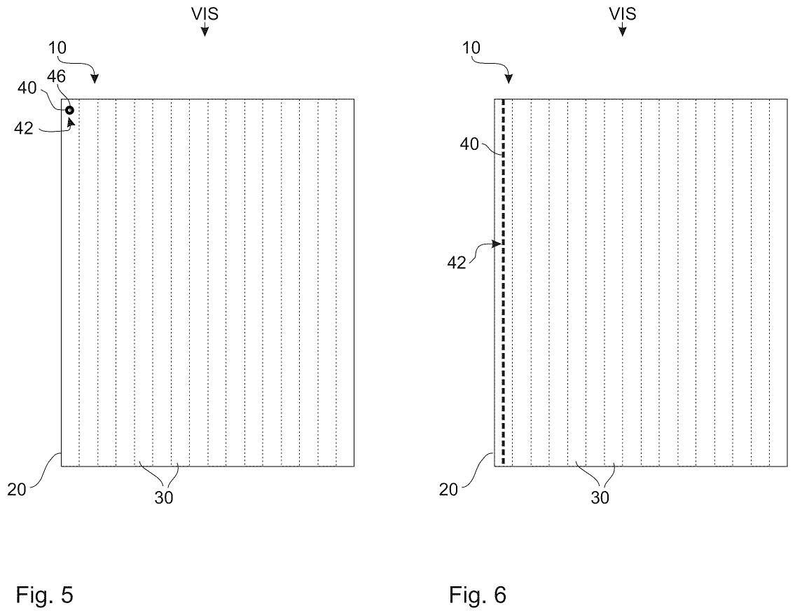

FIG. 5 shows another embodiment of the installation marking 40. The orientation section 42 is provided here with an origin section 46, represented schematically here as a circular logo. Here, there is no information section 44; rather, the information is encoded in that the installation marking 40 should always be arranged at the top left of the film body 20. Here, the bird protection position BPP is indicated in an indirect way, so to speak.

FIG. 6 shows a continuous design of the orientation section 42 of the installation marking 40. This correlates in particular with an additional indication, namely the indication of a trimming allowance TA, which will be explained later.

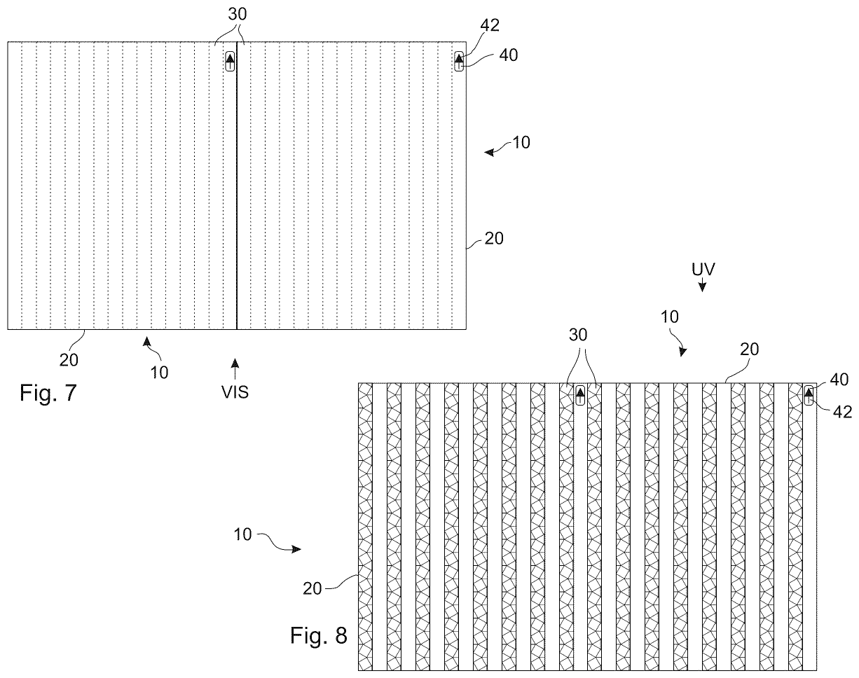

The functional principle for installation is briefly explained with reference to FIGS. 7 to 10. This can clearly be seen in particular if, in the case of wide façade elements 110, two or more film products 10 are to be arranged abutting each other. FIG. 7 shows the correct arrangement of the two adjacent film bodies 20 in the VIS range and FIG. 8 shows the same situation in the UV range. As can clearly be seen here, the right-hand film product 10, as a repeat pattern, seamlessly continues the strip-formed pattern of the UV bird protection sections 30 of the left-hand film product 10. This was ensured because the installer was able to take this desired relative correlation into account in the arrangement in the VIS range through the installation markings 40 of both film products 10.

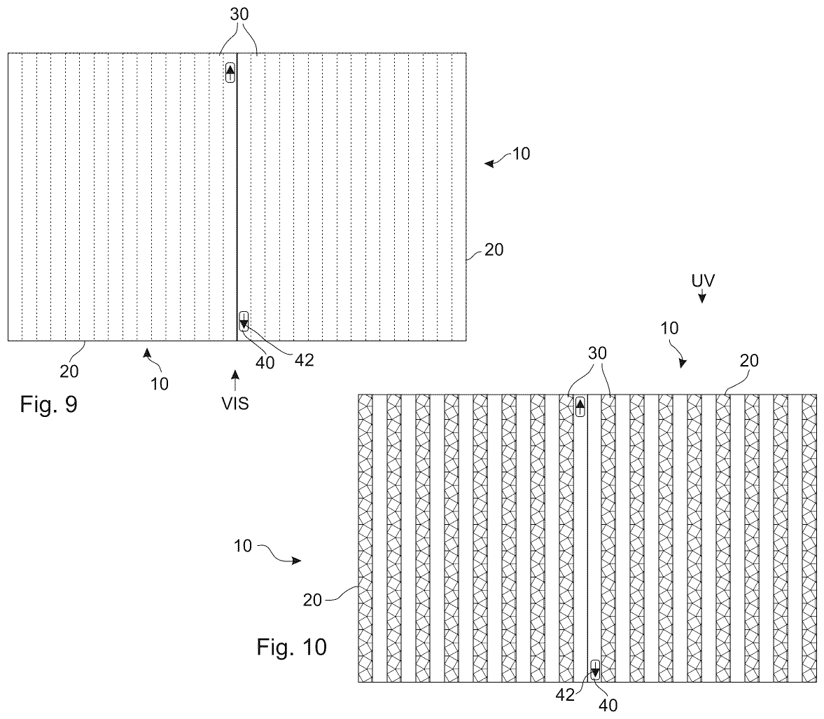

FIGS. 9 and 10 show the same situation, but with an incorrect and thus false relative alignment of the film products 10 in relation to each other. This would be the case if, as shown in the UV range of FIG. 10, the right-hand film product 10 were incorrectly applied, rotated by 180°. This leads to a defective formation of the pattern repeat between the two film products 10 and to the formation of a gap width which is twice as wide, and thus undesirable, between the adjacent UV bird protection sections 30 at the join. This could lead to this larger gap width being perceived by birds as a fly-through path, so that the bird protection function is significantly minimised by this incorrect relative positioning. However, this is avoided, or the risk of such a misalignment is reduced, since, in the VIS range, as shown in FIG. 9, this misalignment is also visible to the installer due to the relative positioning of the two installation markings 40, so that they will recognise this installation as being incorrect and avoid it.

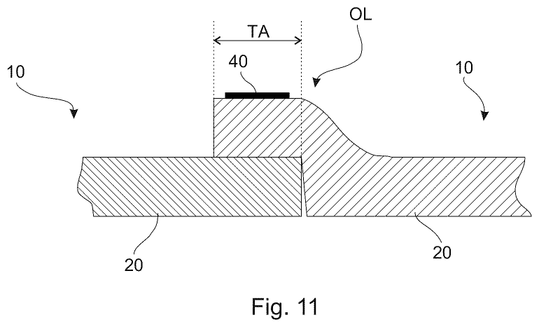

FIG. 11 shows a detail of the abutting arrangement as explained in FIGS. 7 to 10. In order to enable a gap-free arrangement of film products 10 next to each other, in this case an overlap OL is formed during installation which is then trimmed off, preferably after the adhesive connection to the building envelope 100 has been completed. This is referred to here as the trimming allowance TA and is taken into account in particular in forming the geometric correlation of the UV bird protection sections 30 and thus in the formation of the bird protection position BPP. Another advantage of the embodiment of FIG. 11 is that the installation marking 40 is integrated here into the trimming allowance TA, so that, by trimming off the overlap OL as the last installation step, the installation marking 40 is removed from the film product 10 as part of the trimming allowance TA. Thus, after this last step, an installation marking 40 is no longer included, and is no longer included, as an impairment, in the film body 20.

FIG. 12 shows the finished formation, in which the facade elements 110 with their main facade bodies contain the film products 10 and thus the building or building envelope 100 is provided with the desired bird protection function.

The above explanation of the embodiments describes the present invention exclusively in the context of examples. Of course, individual features of the embodiments can be freely combined with each other, where technically expedient, without departing from the scope of the present invention.

### LIST OF REFERENCE SIGNS

10 film product
20 film body
30 UV bird protection section
40 installation marking
42 orientation section
44 information section
46 origin section
100 building envelope
110 façade element
112 main façade body
BPP bird protection position
TA trimming allowance
OL overlap
UV UV range
VIS VIS range

1-17. (canceled)

18. A film product configured to be applied to a transparent section of a building envelope to aid in protection of the building from bird strikes, the film product comprising:
a film body with a planar extension, the film body having a plurality of UV bird protection sections that provides a UV bird protection function, each of the plurality of UV bird protection sections having an optical effect in a UV range, the plurality of UV bird protection sections having a bird protection position in relation to the film body; and
an installation marking with an optical effect in the VIS range that is visible to humans, the installation marking being oriented to aid in indicating the bird protection position of the plurality of UV bird protection sections.

19. The film product of claim 18, wherein the installation marking includes an orientation section that has an orientation and/or a position which correlates with an orientation of the plurality of UV bird protection sections

20. The film product of claim 19, wherein the orientation section is aligned along the orientation of the plurality of UV bird protection sections.

21. The film product of claim 19, wherein the orientation section at least partially corresponds to the bird protection position.

22. The film product of claim 19, wherein the orientation section has an information section which provides visual information about the bird protection position.

23. The film product of claim 18, wherein a surface side of the film body is provided with a cover film, in particular to cover an adhesive surface of the surface side, and wherein the installation marking is at least partially arranged in and/or on the cover film.

24. The film product of claim 18, wherein the installation marking is part of the film body.

25. The film product of claim 24, wherein the installation marking has a temporary effect in the VIS range.

26. The film product of claim 18, wherein the installation marking is continuous and/or repetitive.

27. The film product of claim 19, wherein the orientation section has a visibility at the edge of a spectrum visible to humans towards the UV range.

28. The film product of claim 19, wherein the orientation section has a visibility in a range between about 5 nanometers and about 20 nanometers from the UV range.

29. The film product of claim 19, wherein the installation marking includes an origin section configured to indicate an origin of the film product.

30. The film product of claim 29, wherein the origin section is at least partly formed by the orientation section.

31. The film product of claim 18, wherein the installation marking is only visible from one side of the film body.

32. The film product of claim 18, wherein the bird protection position of the plurality UV bird protection sections includes a trimming allowance which is configured to be trimmed off during installation of the film product on the building envelope.

33. The film product of claim 32, wherein the installation marking indicates the trimming allowance in a qualitative manner and/or a quantitative manner.

34. The film product of claims 32, wherein the installation marking is at least partly arranged in the trimming allowance.

35. A method for applying a film product to a building envelope, the method comprising:
determining a bird protection position of a plurality of UV bird protection sections using an orientation section of the film product;
arranging the film product on the building envelope based at least in part on the determined bird protection position; and
fixing the film product to the building envelope in the arranged position.

36. The method of claim 35, wherein the film product is fixed to the building envelope directly adjacent to second film product already applied to the building envelope.

37. The method of claim 36, further comprising arranging the film product such that an overlap portion of the film product overlaps the second film product.

38. The method of claim 37, further comprising trimming off, from the film product, the overlap portion of the film product.
